(19) United States
(12) Patent Application Publication
(10) Pub. No.: US 2012/0124369 A1
(43) Pub. Date: May 17, 2012

(54) SECURE PUBLISHING OF PUBLIC-KEY CERTIFICATES

(76) Inventors: Jose Castejon Amenedo, Fort Collins, CO (US); Joe Gersch, Loveland, CO (US); William S. Worley, JR., Centennial, CO (US)

(21) Appl. No.: 13/293,102

(22) Filed: Nov. 9, 2011

Related U.S. Application Data
(60) Provisional application No. 61/411,895, filed on Nov. 9, 2010.

(51) Int. Cl. H04L 29/06

(52) U.S. Cl. 713/156

(57) ABSTRACT

The current application is directed to methods and systems for secure distribution of public-key certificates using the domain name system with security extensions (“DNSSEC”), a publisher component, and additional client-side functionality. These methods and systems, when combined with public/private-key-based cryptography used for encrypting digitally encoded information, provides a computationally efficient and well-understood method and system for secure communications and digitally-encoded-information verification without current difficulties and inefficiencies attendant with distributing and managing the public keys used for encrypting digitally encoded information.

### CROSS-REFERENCE TO RELATED APPLICATION

This application claims the benefit of Provisional Application No. 61/411,895, filed Nov. 9, 2010.

### TECHNICAL FIELD

The current application is related to secure electronic communications. cryptography, and the domain name system and, in particular, to a secure method for publishing public-key certificates using the domain name system security extensions.

### BACKGROUND OF THE INVENTION

Significant developments in information science, cryptography, and electronic-communications hardware and software have led to advancement in secure communications that allow individuals, using personal computers, to securely exchange messages and files through generally unsecure public communications networks and systems, including the Internet. Many types of secure communications are based on public/private-key-based cryptography, including the RSA system named for the inventors Rivest, Shamir, and Adleman. Additional types of public/private-key-based cryptographic methods, including methods based on elliptic curves and various computationally difficult one-way problems, have been developed even more recently than the RSA algorithm.

While, in principle, public/private-key-based cryptographic methods can be used to securely transmit information between computers, the distribution and management of public keys among communicating individuals and computer systems presents a variety of technical and conceptual problems that frustrate computer users and system administrators, constrain access to secure communications, and present numerous security issues with respect to repeated and on-going secure communications.

Because of the computational efficiency and desirable functionality of public/private-key-based cryptography and secure communications, system developers, networking and communications developers, manufacturers and vendors of computers and communications equipment, and ultimately users, system administrators, and information-technology personnel continue to seek methods and systems that provide fully secure communications based on the computationally efficient and well-understood public/private-key-based cryptographic methods.

### SUMMARY OF THE INVENTION

The current application is directed to methods and systems for secure distribution of public-key certificates using the domain name system with security extensions (“DNSSEC”), a publisher component, and additional client-side functionality. These methods and systems, when combined with public/private-key-based cryptography used for encrypting digitally encoded information, provides a computationally efficient and well-understood method and system for secure communications and digitally-encoded-information verification without current difficulties and inefficiencies attendant with distributing and managing the public keys used for encrypting digitally encoded information.

### BRIEF DESCRIPTION OF THE DRAWINGS

FIG. 1 illustrates encryption and decryption processes.

FIG. 2 summarizes three different encryption-based techniques.

FIG. 3 illustrates the structure of an X.509 public-key certificate.

FIGS. 4A-J illustrate a simplified, public/private-key-based secure information exchange between a user and a remote responder as well as a hypothetical scenario in which the secure information exchange can be breached or thwarted by a malicious third party.

FIG. 5 illustrates human-readable email-address resolution by the domain name system (“DNS”) recently updated with security extensions to the secure domain name system (“DNSSEC”).

FIG. 6 illustrates the logical hierarchical organization of DNSSEC.

FIG. 7 illustrates additional subdomains and subzones of the “.acme” domain corresponding zone.

FIG. 8 illustrates the information stored within the DNSSEC databases of DNSSEC servers.

FIG. 9 illustrates data flow to and from zone data managed within DNSSEC servers of a DNSSEC zone.

FIG. 10 illustrates the extension of the DNSSEC that makes possible the currently disclosed CDMS.

FIG. 11 illustrates additional components of the CDMS to which the current application is directed.

FIG. 12 shows components of the CDMS for a hypothetical Ajax Corporation.

FIG. 13 illustrates, using a control-flow diagram, a DNSSEC certificate query carried out by a mail server or other DNSSEC publisher to retrieve a public-key certificate.

FIG. 14 illustrates execution of a DNSSEC published-cert query by a DNS server.

FIGS. 15A-B illustrate implementation of the publish function of the publisher interface.

FIGS. 16A-C illustrate implementation of the create publisher function.

FIG. 17 provides a block diagram of a generalized computer system on which components of the certificate distribution and management system are implemented.

### DETAILED DESCRIPTION OF THE INVENTION

The current application is directed to methods and systems for secure distribution of public-key certificates using the domain name system with security extensions (“DNSSEC”), a publisher component, and additional client-side functionality. These methods and systems, when combined with public/private-key-based cryptography used for encrypting digitally encoded information, provides a computationally efficient and well-understood method and system for secure communications and digitally-encoded-information verification without current difficulties and inefficiencies attendant with distributing and managing the public keys used for encrypting digitally encoded information.

In the following discussion, an overview of public/private-key-based cryptography is first provided followed by an example illustrating potential security breaches that may occur despite the use of public/private-key-based cryptography encrypting information prior to transmission through public communications networks. Next, an overview of the domain name system (“DNS”) and the DNS security extensions (“DNSSEC”) is provided. Finally, following these initial discussions, methods and systems to which the current application is directed provide for peer distribution and management of public-key certificates in order to facilitate public/private-key-based peer communications is disclosed with reference to high-level illustrations and control-flow diagrams.

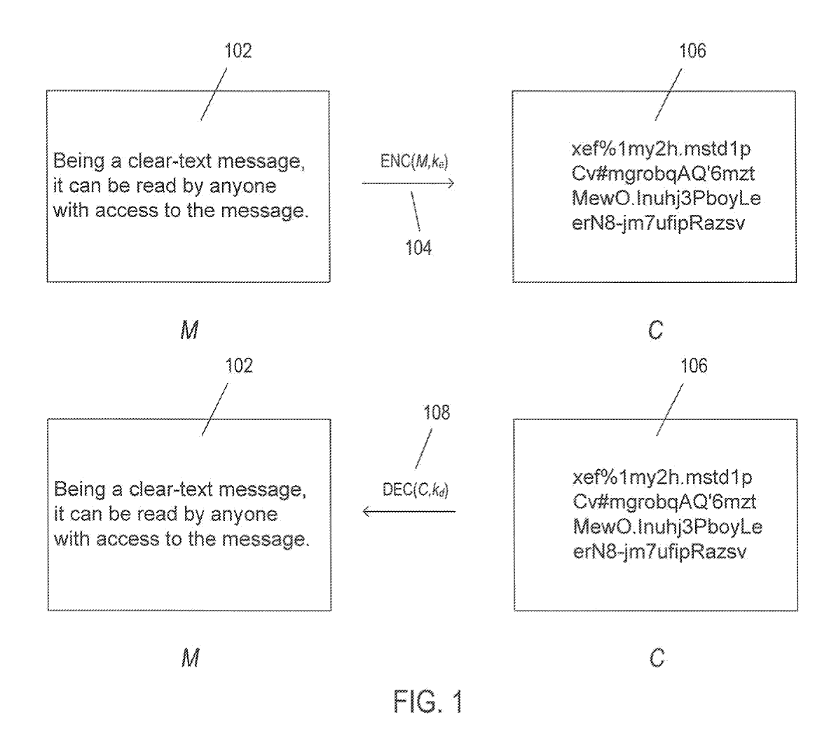

Encryption methods transform a digitally encoded sequence of symbols, including text and numerical data, into a corresponding encrypted symbol sequence that cannot be straightforwardly read or interpreted, in general, but that contains the same information that is contained in the original symbol sequence that was encrypted to produce the encrypted symbol sequence. A party possessing a decryption key or other decryption-facilitating information can carry out an inverse transformation to regenerate the original symbol sequence. FIG. 1 illustrates encryption and decryption processes. As mentioned above, encryption is used to transform a clear-text message or symbol string into encrypted form which cannot be interpreted by normal symbol-string interpretation algorithms, such as by reading natural-language statements. Decryption is the inverse process by which encrypted symbol strings are transformed back to clear-text form. In FIG. 1, an initial natural-language message M 102 is transformed, by encryption 104, to an encrypted message C 106. In the current discussion, the expression “ENC(M, kₑ)” stands for encryption of message M using encryption key kₑ. As is obvious by comparing clear-text message M with encrypted message C, the meaning of encrypted message C cannot be extracted by normal text-processing means. Instead, an encrypted message C needs to be first reverse-transformed back to a clear-text message by the decryption process 108. The expression “DEC(C, k_{d})” stands for decryption of encrypted message C using decryption key k_{d}. This can be alternatively expressed as “ENC⁻¹ (C, k_{d}).”

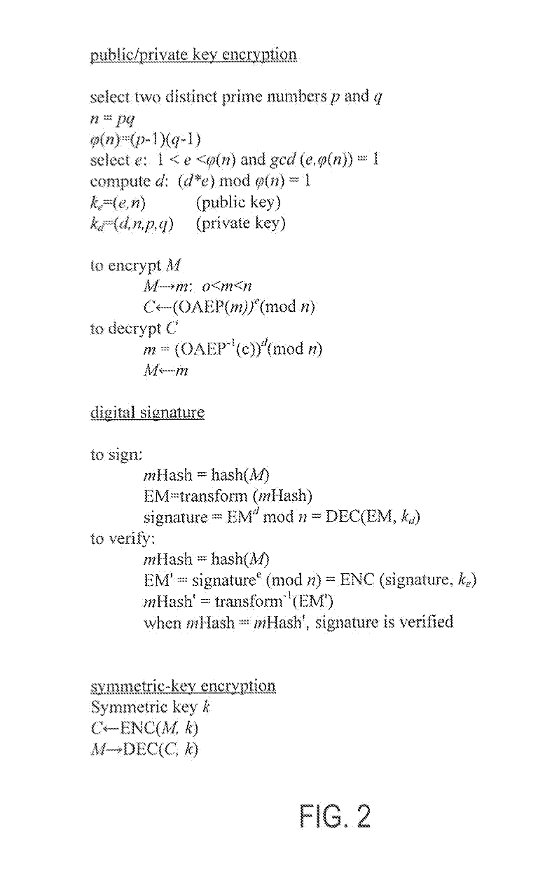

FIG. 2 summarizes three different encryption-based techniques referred to in the following discussion. Public-key/private-key encryption is widely used in commercial transactions and information-exchange protocols. One commercially successful public-key/private-key encryption/decryption technique is referred to as the “RSA” encryption/decryption technique, where RSA includes the first letters of the last names of the inventors of the method: Rivest, Shamir, and Adleman. In this encryption/decryption technique, pairs of encryption/decryption keys are generated. In general, the encryption key is publically distributed, and referred to as the “public key,” while the decryption key is held in secret by an encrypted-message-receiving party and referred to as the “private key” or “secret key.” In normal usage, anyone can access the public key and encrypt a message using the public key, but only the receiving party in possession of the secret key can decrypt and read the encrypted message. For secure communications, two parties can exchange their public encryption keys so that each party can encrypt a message and transmit the encrypted message to the other party for decryption and reading only by the other party.

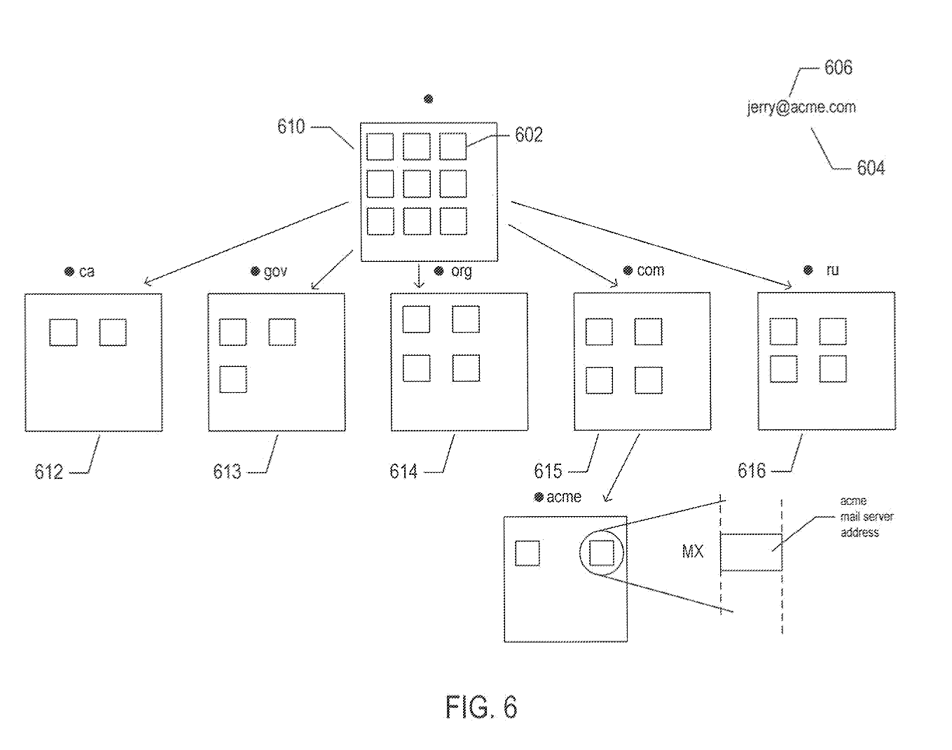

To generate an encryption/decryption key pair by the RSA method, two prime numbers p and q are first selected, and the product n=pq is computed and stored. Next, the product φ(n) is computed as (p-1)(q-1). Next, an integer e in the range (1, φ(n)) is selected such that the greatest common divisor of e and φ(n) is 1. A corresponding integer d is computed such that (d*e) mod φ(n)=1. The public encryption key kₑ is the pair of integers (e,n) and the private, or secret, decryption key k_{d} is the four-tuple (d, n, p, q) or the three-tuple (d, p, q). To encrypt a message M, M is transformed to an integer m in the range (0,n), the integer m is then subjected to the Optimal Asymmetric Encryption Padding (“OAEP”) randomized padding scheme, and is then raised to the power e modulo n or, as shown in FIG. 6:

C←(OAEP(m))^{e} mod n.

To decrypt the encrypted message C, the integer m is recovered by applying the inverse of the randomized padding scheme to the encrypted message C, raising the result to the power d modulo n or, as shown in FIG. 6:

m=OAEP⁻¹(C^{d} mod n)

and then the integer m is transformed back into message M by the inverse of the forward transformation of M to m, carried out as the first step of the encryption method.

The RSA encryption/decryption method can also be used to digitally sign a message to provide for message authentication. First, a one-way cryptographic hash function is applied to the message M to produce a hash value mHash. Then, a transform is applied to mHash to generate an encoded message EM. Finally, a signature for the message is generated by raising EM to the power d modulo n, equivalent to applying the RSA decryption method, using secret key k_{d}, to EM. The signature can be appended to message M. A recipient of the message can verify the message by first generating mHash as in the signing method. The recipient then applies the RSA encryption method to the signature to generate a value EM═ or, as expressed in FIG. 6:

EM′=signature^{e}(mod n)=ENC(signature, kₑ).

Then, a reverse transform is applied to EM′ to generate mHash′. When mHash′ is equal to mHash, or the hash value generated by applying the one-way cryptographic hash function to message M, the signature is verified. Note that the signer of the message uses the signer's private or secret key while the message can be verified by anyone with access to the corresponding public key of the signer. Verification indicates that the text of a received message M is identical to the text in an original message M that was signed by the signer in possession of the secret key k_{d}.

Finally, other types of encryption/decryption methods employ a single symmetric key. In this case:

C←ENC(M, k)

M←DEC(C, k).

Symmetric-key encryption uses a single key k for both encryption and decryption. There are many different types of symmetric key encryption. One example is the Advanced Encryption Standard (“AES”). In general, symmetric-key encryption employs a series of deterministic operations for encryption that can be inverted for decryption. For symmetric-key encryption, the encryption key k is generally held in secret by both communicating parties since, once revealed, the message is encrypted using the key k can be readily decrypted when the particular symmetric-key-encryption method is known.

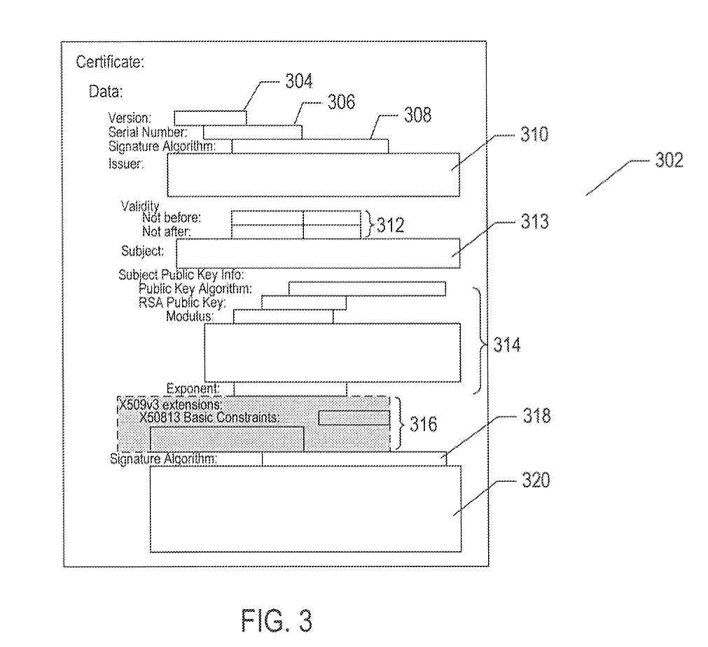

Public-key certificates, including certificates that follow the X.509 ITU-T standard, are frequently used in secure communications for verifiably binding a public key to a name or identifier, such as an email address. FIG. 3 illustrates the structure of an X.509 public-key certificate. The X.509 certificate 302 is essentially a data record that contains a sequence of standard fields that contain information needed to employ the certificate for verifying the binding, or association, of a user identifier or system identifier with a public key. These fields include a certificate version number 304, a serial number 306 that is unique with respect to a particular certificate authority that issues public-key certificates, an encoding of an identifier for the cryptographic algorithm used to compute a signature over the certificate 308, information that identifies the issuer of the certificate 310, two date and time values 312 that indicate the beginning date and time at which the certificate becomes valid and the ending date and time at which the validity of the certificate ends, identifying information for the user or system that is bound by the certificate to a public key 312, a group of fields that indicate the cryptographic algorithm for which the public key is used and that include the public key 314, optional fields 316, referred to as extensions, that include additional information, an indication of the signature algorithm 318, and the signature computed by the issuing entity over the remaining fields of the certificate 320.

In general, public-key certificates are issued by trusted computer systems with entrusted organizations referred to as “certificate authorities.” There are well-known certificate-issuing organizations that provide issuing of public-key certificates as a commercial service. These organizations employ various information-gathering techniques to verify the identity of a requesting entity prior to issuing the certificate. The public-key certificate can be transmitted, by an entity possessing the certificate, to other entities in order to facilitate secure communications via encryption and to allow the certificate holder to digitally sign information can be verified by use of the public key by those to whom the certificate holder transmits the certificate.

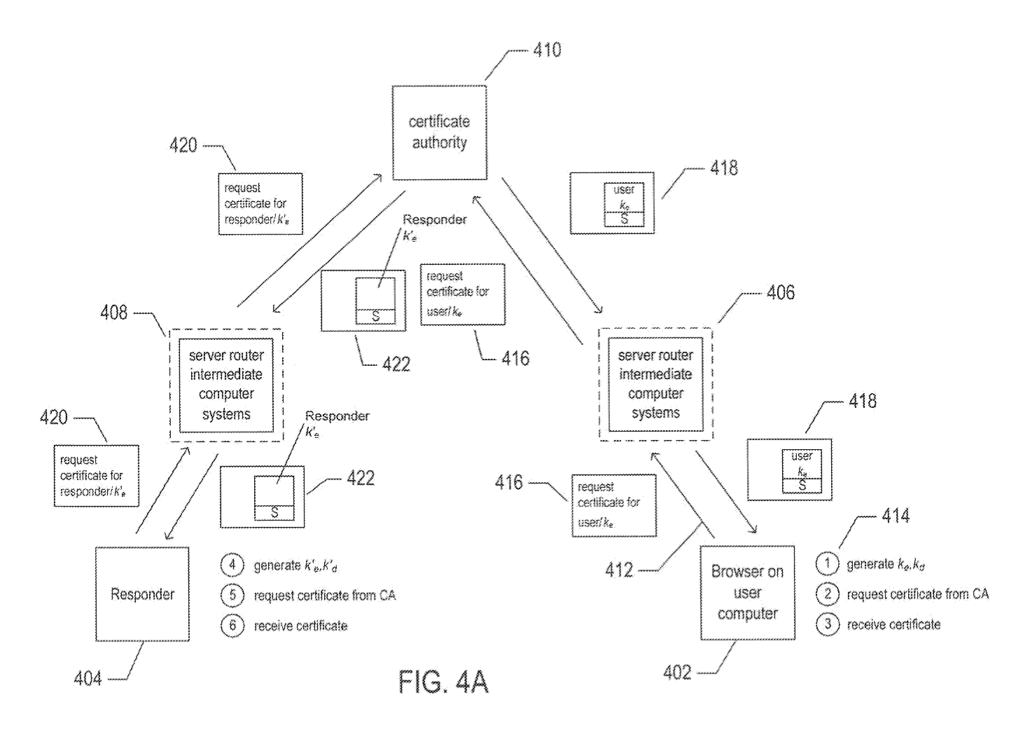

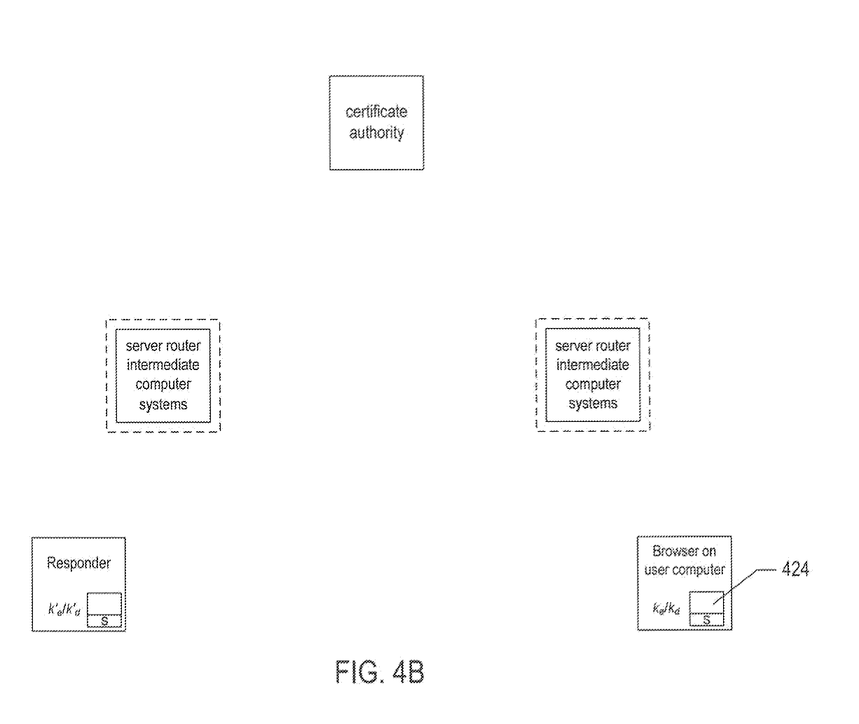

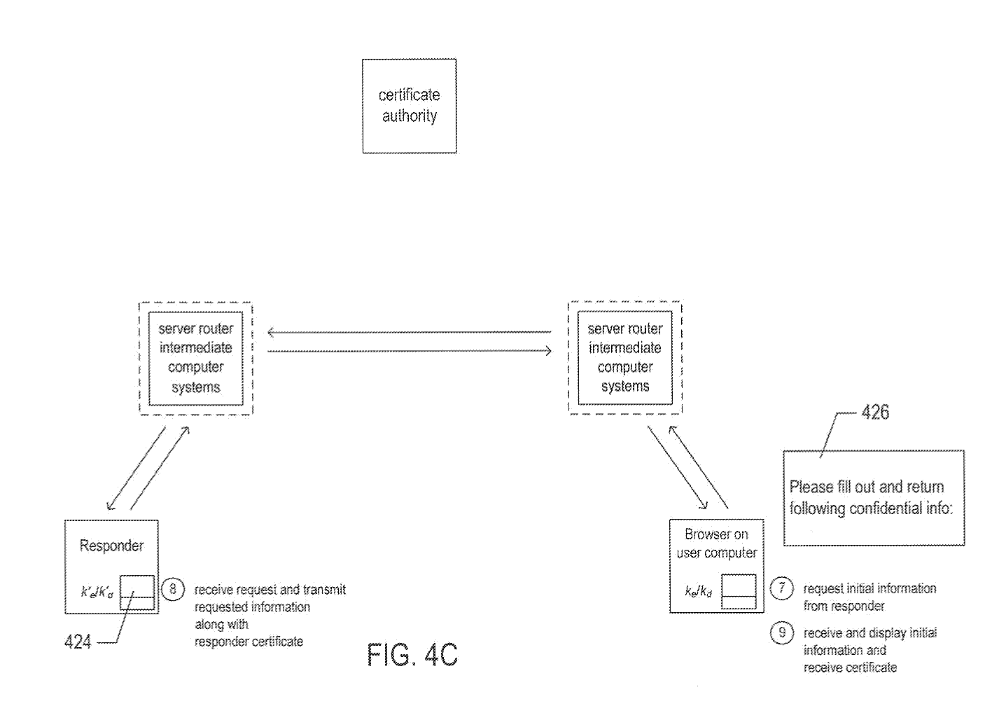

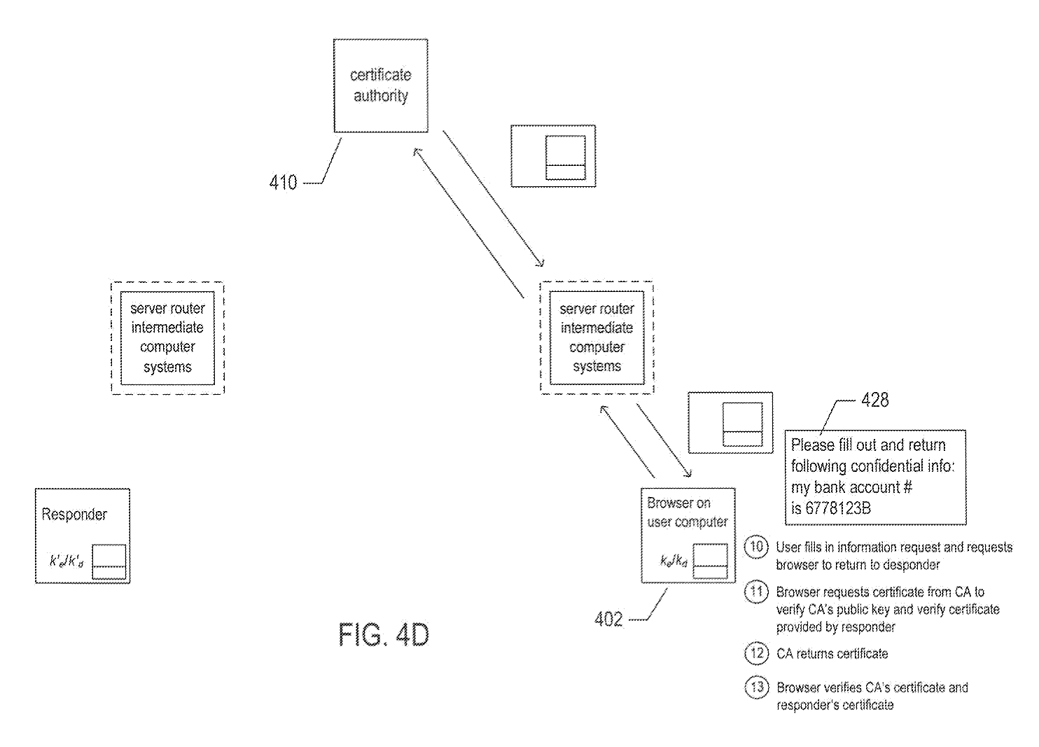

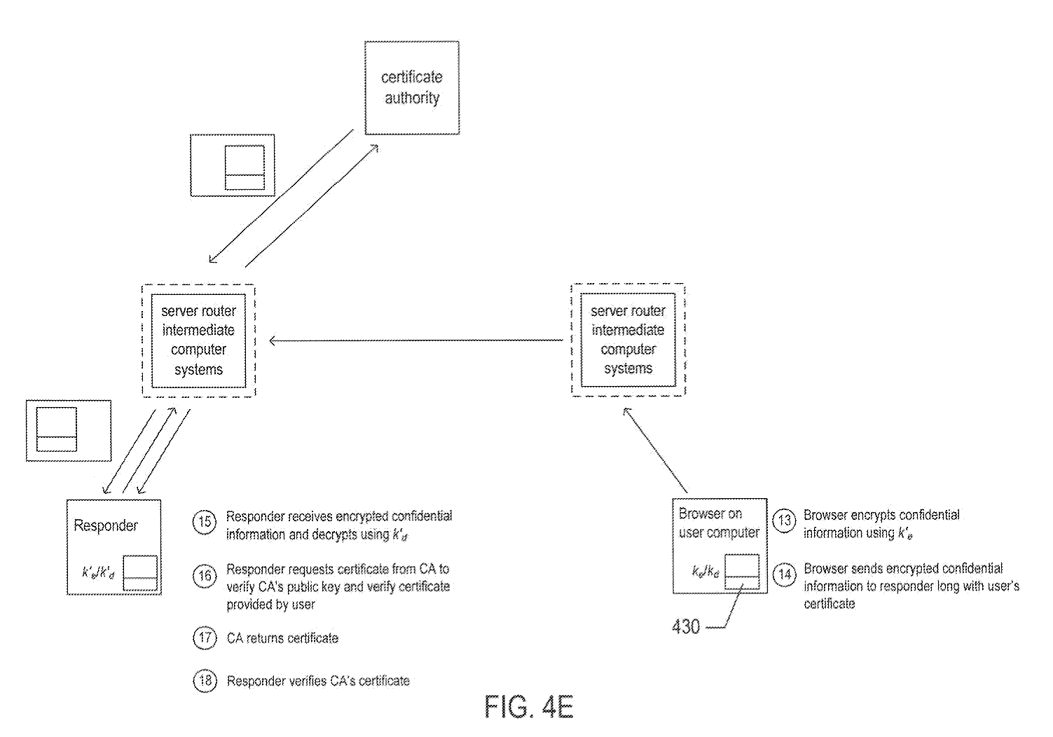

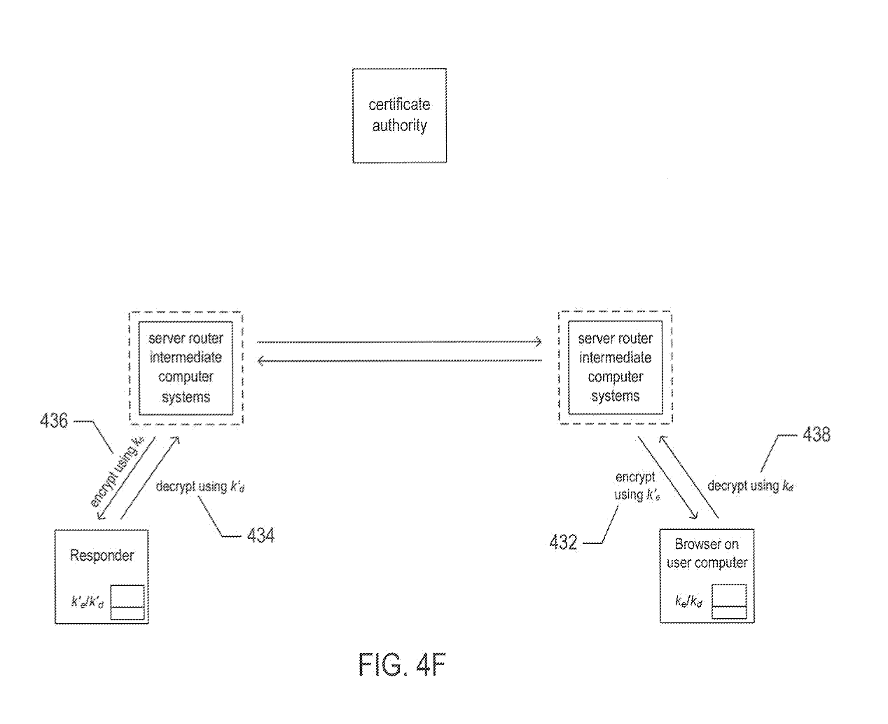

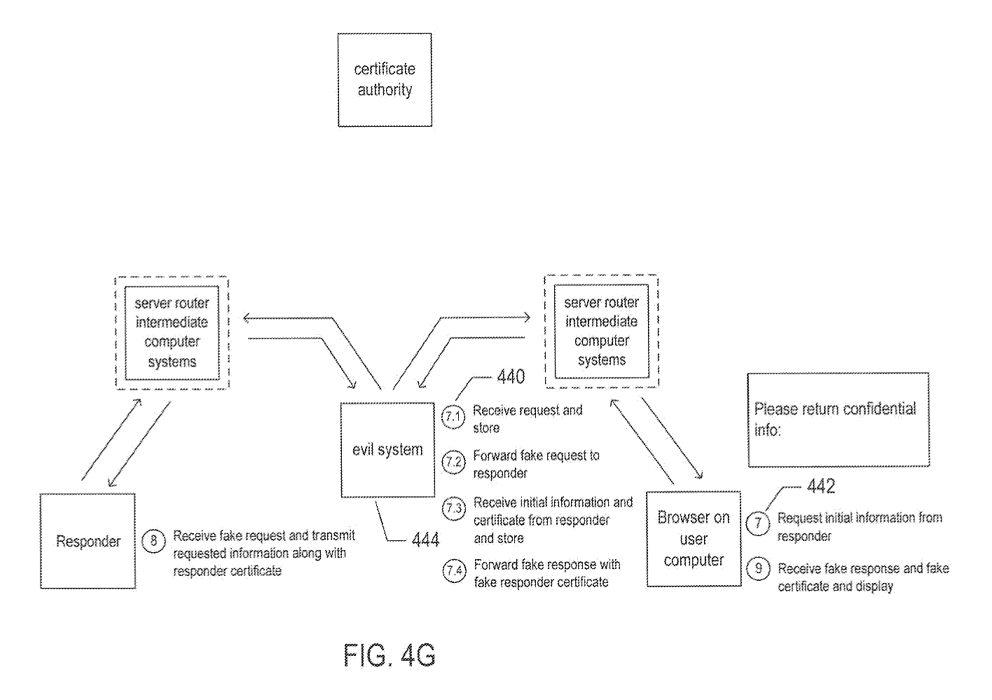

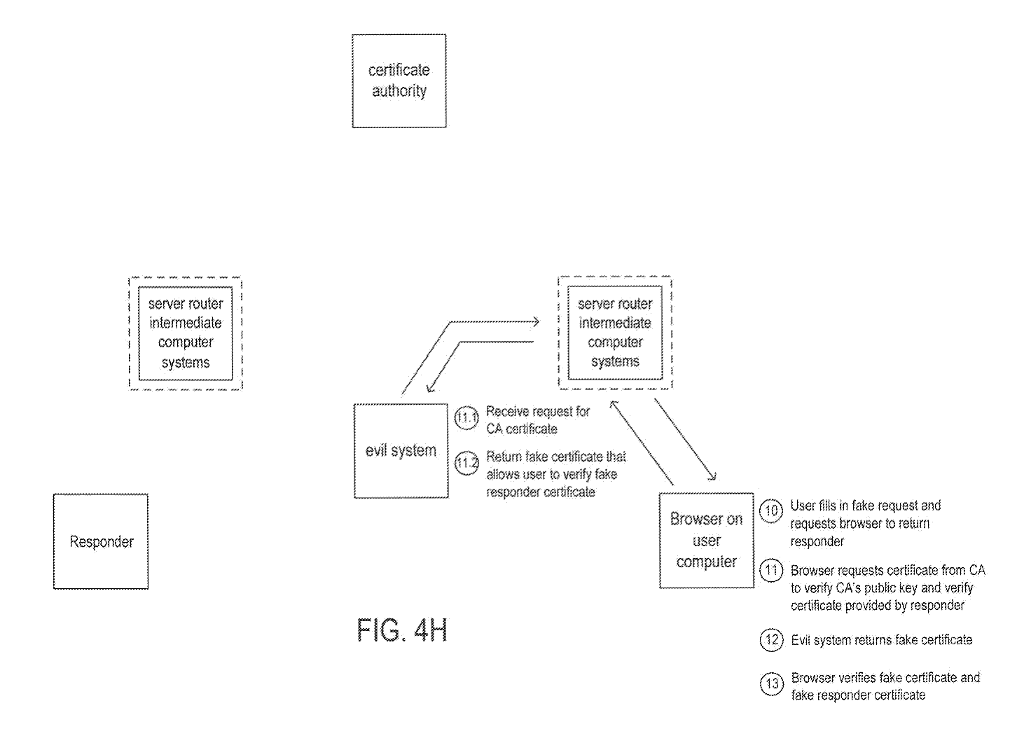

FIGS. 4A-J illustrate a simplified, public/private-key-based secure information exchange between a user and a remote responder as well as a hypothetical scenario in which the secure information exchange can be breached or thwarted by a malicious third party. FIGS. 4A-J all use the same illustration conventions, next described with reference to FIG. 4A. The various computer systems are represented in FIGS. 4A-J by rectangles, such as rectangle 402 representing a user computer, rectangle 404 representing a responder computer, rectangle 406 representing one or more intermediate computers that interconnect the user computer to remote computers via the Internet or another public network, rectangle 408 that represents intermediate computers that interconnect the responder computer 404 with the Internet or another public network, and one or more computer systems 410 within an organization that serves as a certificate authority. Arrows, such as arrow 412, indicate transmission of information as one or more messages or packets from one computer to another, with certain of the arrows labeled with indications of the type of message being sent. Finally, the figures include numerically labeled indications of the steps involved in the information exchange, the numerical labels indicating the order of the steps in the sequence, such as circled numerical label “1” 414 indicating the first step in the process.

In a first step, the browser on the user's computer, in certain cases in response to certain user inputs, and in other cases in response to internal events, generates a new public/private key pair kₑ/k_{d} and then requests a public-key certificate from the certificate authority 410 via a request message 416. The request message is sent through various severs and routers 406 and intermediate routing systems within the public network to the certificate authority 410. In general, although not shown in FIG. 4A, the certificate authority would undertake information exchange with the browser on behalf of the user in order to obtain sufficient information to verify the user's identity and IP and email addresses. Upon verification, a certificate authority 410 returns a public-key certificate, such as the X.509 certificate discussed above with reference to FIG. 3, in a message 418 to the user. Similarly, the responder computer, in certain cases through a browser or application program, also generates a public/private key pair k′ₑ/k′_{d}, requests a certificate for the public key k′ₑ from the certificate authority in a request message 420 and, upon verification, receives a public-key certificate from a certificate authority in a response message 422. Note that the responder may use a different certificate authority than the certificate authority used by the user although, in FIG. 4A, the same certificate authority 410 is shown as being used by both the user and responder.

Thus, as a result of the certificate requests and responses illustrated in FIG. 4A, both the user computer and responder computer have stored public/private keys as well as certificates for their respective public keys. FIG. 4B illustrates this state of the user computer and responder computer prior to initialization of an information exchange. In FIG. 4B, as in other figures of FIGS. 4A-J, the public-key certificates are represented by rectangles, such as rectangle 424, with the lower section labeled “S” representing the signature over the certificate generated by the certificate authority using the certificate authority's private key.

Next, in FIG. 4C, the browser on the user computer, generally in response to user input, generates a request for initial information from the responder and transmits that request to the responder. In response, the responder computer returns an HTML file or other encoded information to the user computer along with the responder computer's public/key certificate 424. The browser on the user computer receives this response and displays the initially requested information to the user in, for example, a displayed web page 426. The web page requests that the user provides to the responder computer certain confidential user information.

As shown in FIG. 4D, the user inputs the information into the browser 428 and then inputs an indication to the browser to send the information back to the responder. Next, the browser requests, from the certificate authority 410, verification of the public-key certificate sent by the responder to the user computer. As one example, the browser may request a self-signed certificate-authority public-key certificate that establishes a binding between the certificate authority and the public key that can be used to verify the signature on the public-key certificate sent from the responder computer to the user computer. Upon receiving the requested public-key certificate, the browser verifies both that received public-key certificate as well as the responder's public-key certificate. Then, as shown in FIG. 4E, the user browser encrypts the confidential information supplied by the user using the responder's public key k′ₑ and sends the encrypted confidential information along with the user computer's public-key certificate 430 back to the responder computer. The responder computer receives the encrypted confidential information and decrypts the encrypted confidential information using the responder's private key k′_{d}. The responder additionally requests a certificate-authority public-key certificate from the certificate authority to use to verify the certificate authority and the user's public-key certificate and, upon receiving the certificate-authority public-key certificate, verifies the user's public-key certificate transmitted to the responder.

Thus, after this initial information exchange, the browser on the user computer has verified that the responder is associated with the responder's public key or the responder's public-key certificate and has verified the responder with respect to the responder's key address and other identifying information. Similarly, the responder has verified the association between the user and the user's public key and has verified the user's IP address and other information associated with the user. As shown in FIG. 4F, the responder and user can now continue to exchange information securely by using public/private-key-based encryption, with the user computer encrypting information sent to the responder computer using the responder computer's public key k′ₑ 432, the responder computer decrypting information sent by the user computer using the responder computer's private key k′_{d} 434, the responder computer encrypting information transmitted to the user computer using the user computer's public key kₑ 436 and the user computer decrypting information received from the responder computer using the user computer's private key k_{d} 438.

While the public/private key-based computer communications, illustrated in FIGS. 4A-F provide a significant degree of security and confidentiality with respect to eavesdroppers and other malicious users that may intercept one or more transmitted messages from either the user computer or the responder computer, secure communications provides only degree of security, and does not provide absolute security. FIGS. 4G-J illustrate a hypothetical scenario in which a malicious third party is able to breach the secure communications illustrated in FIGS. 4A-F in order to obtain a clear text version of the encrypted information transmitted by the user computer. FIGS. 4G-J illustrate the same information exchange illustrated in FIGS. 4C-F, but includes the malicious third party and additional steps carried out by the malicious third party. These additional steps have two-part numerical labels, such as the numerical label “7.1” 440 indicating this step occurs following step “7” 442. When the user browser sends the initial information request to the responder, the malicious third party, or evil system 444 intercepts the request and stores it. The evil system then constructs a fake request from the evil system using the evil system's IP address to the responder that includes the same information that was included in the initial request sent by the user computer. This fake request is transmitted to the responder computer which responds as in the scenario shown in FIG. 4C, with the exception that the response is directed to the evil system rather than the user computer. Upon receiving the fake response, the evil system extracts the responder's public-key certificate and stores it and then forwards the fake response onto the user computer. Thus, the main assumption in the hypothetical scenario is that the evil system 444 is able to intercept messages sent from the user and responder computers. The evil system may, in fact, be one of the routers or intermediate computers normally used for message exchange that has been corrupted by a third party to intercept messages rather than simply forward the messages. The fake response message contains a fake responder certificate that appears to bind the responder computer to the evil system's public key rather than the responder's public key.

Next, the user computer attempts to verify the fake certificate, as before, by requesting a certificate-authority public-key certificate from the certificate authority to use in verifying the signature on the responder's certificate. The request is also intercepted by the evil system which returns a fake certificate-authority of a second evil system public key. The browser on the user computer believes the fake certificate-authority public-key certificate to be valid and uses it to verify the fake responder public-key certificate that was created by the evil system and transmitted to the user's system in response to the user system's initial request to the responder.

As illustrated in FIG. 4I, the user computer next encrypts confidential information using the fake responder public key and transmits it to the responder system. The message is intercepted by the evil system which decrypts the message using the evil system's first private key corresponding to the fake responder public key. Thus, the evil system has managed to obtain the user's confidential information in clear text form. The evil system then encrypts the user computer's confidential information using the responder's public key and transmits the message to the responder. Note that this message contains the user's actual public-key certificate. Thus, a responder receives the message from the evil system and verifies the user's public-key certificate via communications with the certificate authority just as in FIG. 4E.

At this point, as illustrated in FIG. 4J, the user computer and responder computer can continue to exchange information using the supposedly secure public/private-key-based secure communications method of FIGS. 4A-F. However, the evil system has managed to interpose itself in between the user computer and responder computer. As shown in FIG. 4J, in subsequent information exchanges, the user computer encrypts messages sent to the responder computer using the fake responder public key 450, these messages are intercepted by the evil system which decrypts the messages and obtains user confidential information using the first evil system private key 452, and the evil system constructs corresponding messages encrypted using the actual responder's public key 454 and transmits these messages to the responder. The responder decrypts the messages using the responder's private key 456 and responds to the messages by encrypting the response messages using the user's public key 458 and transmitting the encrypted messages back to the responder. The messages can go directly back to the user computer, without evil-system intervention, and be decrypted by the user computer using the user computer's private key 460.

The aspects of the public/private-key-based secured communications that allow the evil system to interpose itself between the user computer and responder is that the evil system is able to generate a fake certificate-authority public-key certificate that cannot be independently verified by the user computer's browser. Certificate-authority public-key certificates are self-signed by the certificate authority. They represent the last link in a supposed chain of trust, but this last link cannot be independently verified. There are, however, many additional points in current public/private-key-based secure communications vulnerable to attack security breaches. Often, browsers and other applications are distributed with pre-loaded certificates for certificate authorities and rely on these certificates for securing communications and transactions. These pre-loaded certificates may be fraudulent or may direct communications to certificate authorities controlled by malicious third parties. There are many inconveniences and administrative and management issues related to distribution and maintenance of public-key certificates. In many cases, actual human users need to obtain public-key certificates from commercial certificate authorities and associate those certificates with their web browsers and other applications. Moreover, the users are burdened with the task of distributing these public-key certificates to potential responders. For various reasons, a public-key certificate may be revoked as, for example, when it appears that security of the corresponding private key may have been compromised. Currently, verification is handled by maintaining large databases of revoked certificates against which any received certificate may be checked. However, this type of revocation checking is computationally inefficient and may suffer from maintenance losses, database failures, and other deficiencies. Thus, for many reasons, while public/private-key-based encryption of digital information for transmission through public networks is well understood, computationally efficient, and effective providing that the association between public keys communicating entities can be verified and providing that public keys can be distributed and properly administered, the current methods for verifying bindings between computers and/or users and public keys and for distributing and administering public keys are inadequate.

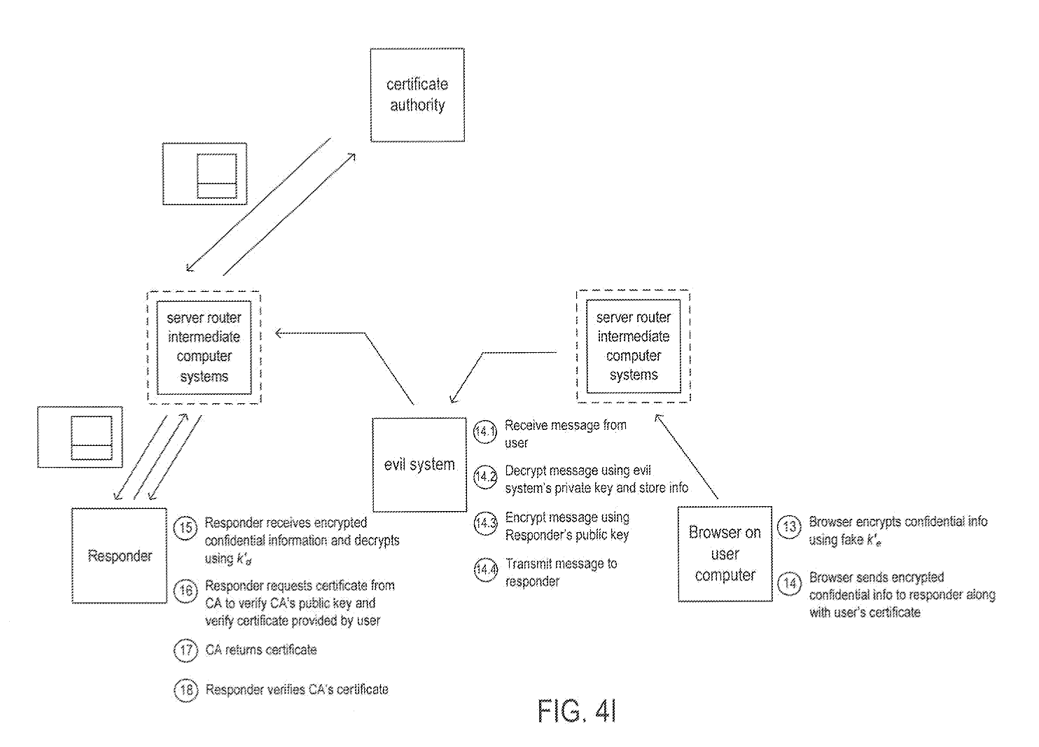

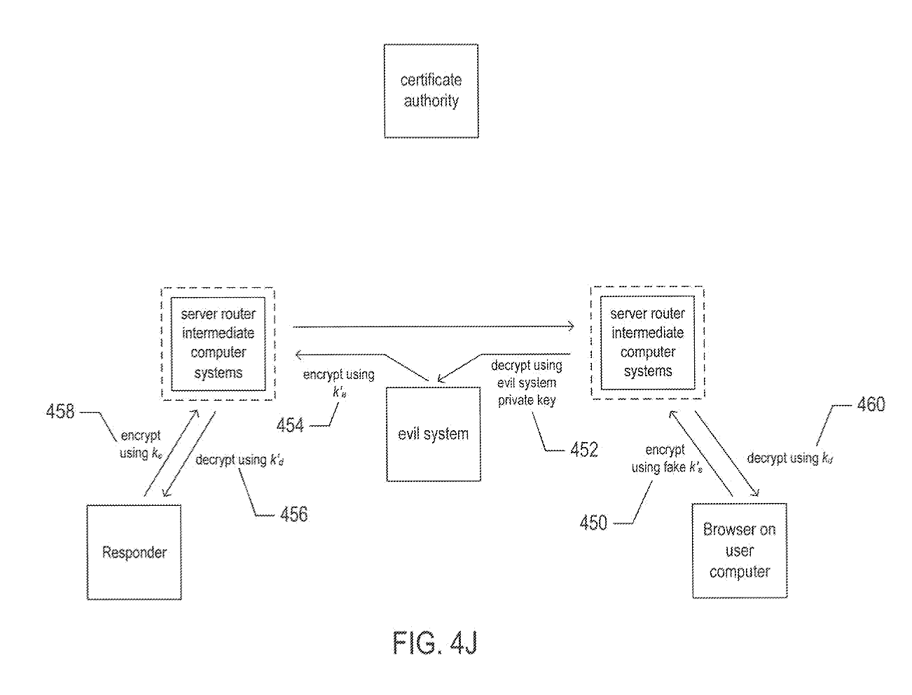

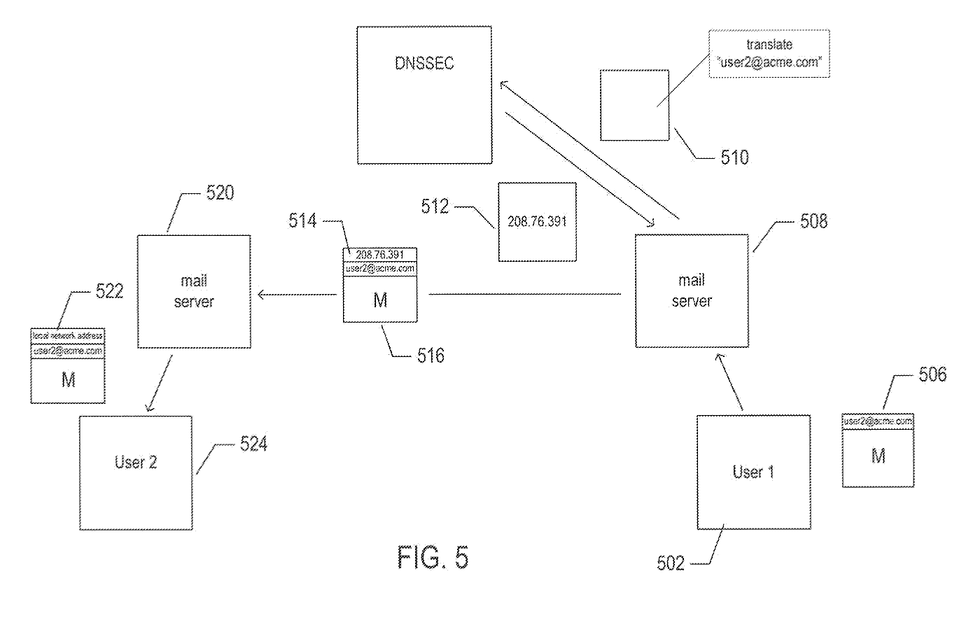

FIG. 5 illustrates human-readable email-address resolution by the domain name system (“DNS”) recently updated with security extensions to the secure domain name system (“DNSSEC”). Email addresses generally have the form “user.name@acme.com,” where the left-hand portion, prior to the symbol “@,” is the name of the user and the right-hand portion, following the symbol “@,” is a human-friendly name for the Internet domain in which the user's mail server physically resides. However, these human-friendly email addresses need to be translated into Internet-protocol (“IP”) addresses which include groups of numbers separated by periods. The IP addresses are digitally encoded with messages and packets for routing of messages and packets through local and public networks and communications systems to their intended destinations. The DNSSEC is a very large, globally distributed database and database-query engine that together provide translations of the human-friendly alphanumeric email addresses to IP addresses. Similarly, the DNSSEC also provides translations of portions of universal resource locators (“URLs”) to IP addresses.

FIG. 5 illustrates email-address translation. In FIG. 5, a first user 502 prepares the email message including the email address of the intended recipient 506 using the user's local mailer application, which sends the message to the user's mail server 508. The mail server then issues a DNS query to the DNSSEC 510 and receives, in response, the IP address 512 corresponding to the email address. Although shown as a single message exchange in FIG. 5, the DNS query may involve many separate information exchanges within the DNSSEC comprising a very large number of individual computer systems. Upon obtaining the IP address, the mail server can insert the IP address into one or more network packets that correspond to the email message 516 and transmit the one or more packets through the public network to the mail server 520 of the intended recipient of the email message. The mail server then translates the user-name portion of the email address into a local network address 522 that is included in the one or more packets corresponding to the email message forwarded by the mail server through a local network to the recipient of the email 524.

FIG. 6 illustrates the logical hierarchical organization of DNSSEC. As shown in FIG. 6, individual computer systems are represented as small rectangles, such as small rectangle 602. One or more individual computer systems may be together considered to be a node in a hierarchical graph of nodes that together comprise the various computer systems, including name servers, within the DNSSEC. The name space of the DNSSEC is also hierarchical in nature. In FIG. 6, a simple email address 604 for a user named Jerry at the Acme Corporation is provided. To the right of the ampersand 606 is a series of domain names separated by periods. There is a logical period at the very right-hand end of the email address that is not included within the domain name. That logical period represents a root domain. Working from the right-hand end of the email address leftward, each next-encountered string of characters delimited by the logical period, explicit periods, and/or the symbol “@” refers to a subdomain in a tree of hierarchically ordered subdomains of the root domain. Thus, for example, in the email address “jerry@acme.com,” a first subdomain below the root domain is specified to be “.com” and a second-level subdomain below the “.com” subdomain is the “.acme” subdomain. The root domain and hierarchically ordered subdomains of the name space therefore constitute a tree-like hierarchical graph with nodes corresponding to domains and subdomains. For example, in FIG. 6, node 610 corresponds to the root domain “.,” while the first-level subdomains “.ca,” “.gov,” “.org,” “.com,” and “.ru” correspond to second-level nodes 612-616. The second-level subdomain “.acme” corresponds to the third-level node 618. The hierarchical name space maps to DNS servers and other computer systems. In FIG. 6, for example, the root domain maps to a large number of computer systems, including computer system 602.

The computer systems are hierarchically arranged into zones and subzones. In certain cases, there may be a one-to-one correspondence between name-space domains and zones, while, in other cases, a zone may maintain information for multiple domains. In FIG. 6, the domains map in one-to-one correspondence with zones. Each zone includes one or more computer systems that execute DNSSEC routines for managing a portion of the DNS name space and for executing DNS queries. Each zone necessarily includes master authoritative name server may additionally include slave authoritative name servers, caching name servers, and other types of functionality. As shown in FIG. 6, the master authoritative name server 620 within the DNSSEC zone corresponding to the “.acme” domain includes a resource record (“RR”) that stores the IP address of the mail server for the “.acme” domain 622. Thus, a DNS query directed by mail server 508 in FIG. 5 to the DNSSEC ultimately involves access to a RR containing the IP address of the acme mail server which is returned to the mail server in a response message 512. The actual RR accessed may be a copy of the RR stored in the master authoritative name server. The copy may be accessed from a caching server or slave authoritative name ser, for example.

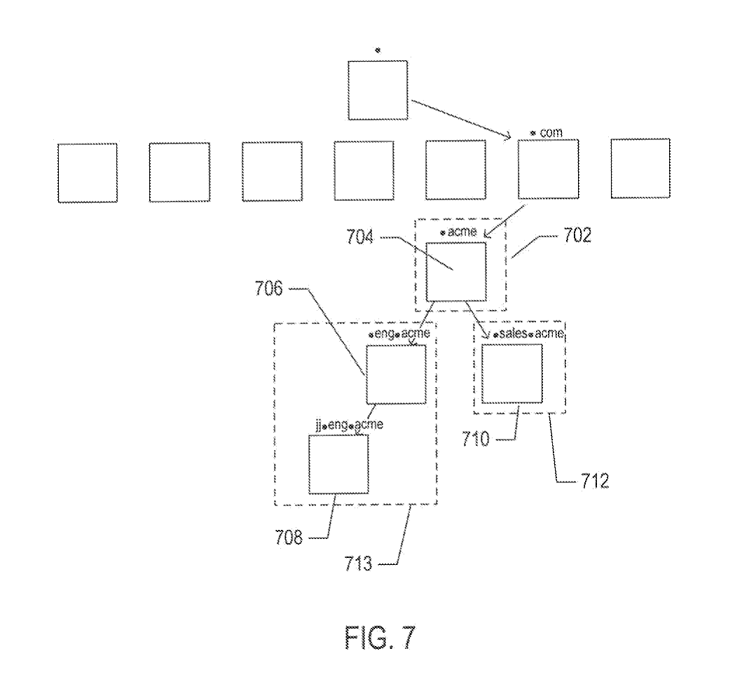

FIG. 7 illustrates additional subdomains and subzones of the “.acme” domain corresponding zone. As in FIG. 6, there is a zone 702 corresponding to the “.acme” domain 704. This zone may comprise one or more computer systems executing the DNSSEC routines that implement the name-space databases, query-execution engines, and other functionalities. As shown in FIG. 7, the “.acme” subdomain may additionally include subdomains “eng.acme,” “jj.eng.acme,” and “sales.acme,” 706, 708, and 710 respectively. The first two of these three subdomains are together managed by subzone 710 of zone 702 and the third of these subdomains is managed by subzone 712.

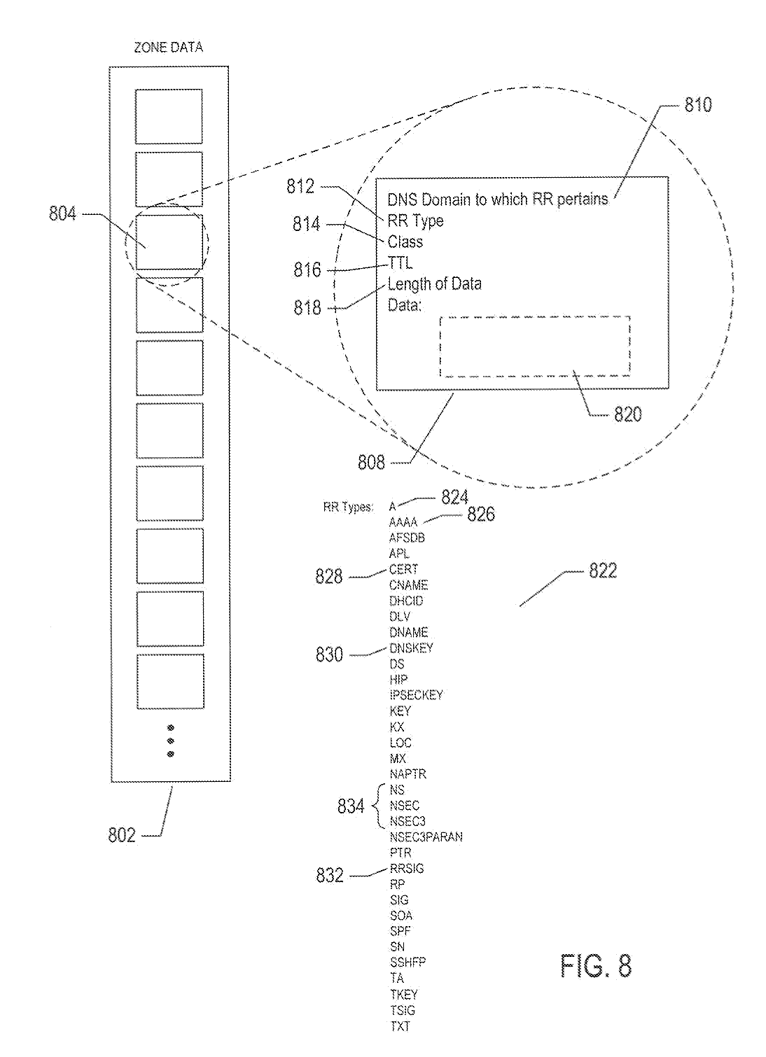

FIG. 8 illustrates the information stored within the DNSSEC databases of DNSSEC servers. The domain-name information corresponding to a zone is generally stored within resource records (“RRs”). In FIG. 8, the data stored and managed for a zone 802 is shown to comprise a large number of RRs, such as RR 804 shown in greater detail in inset 806. An RR is a data record 808 that includes an indication of the DNSSEC domain to which the RR pertains 810, an indication of the RR type 812, an indication of the class to which the RR belongs 814, an indication of the amount of time that the record remains valid 816, an indication of the length of data included in the record 818, and the data contained within the record 820 appropriate to the particular RR type. In FIG. 8, a partial list of RR types is provided 822. These record types include the types “A” 824 and “AAAA” 826 that store 32-bit and 128-bit IP addresses, respectively. In addition, other types include the type “CERT” 828 that stores a digital certificate, such as a public-key certificate, used internally within the DNSSEC system for various purposes, including secure communications. RR types further include the “DNSKEY” and “RRSIG” RR types 830 and 832. These record types are returned along with another type of RR that responds to a DNSSEC query. The RRSIG RR includes a signature for the query-response RR and the DNSKEY record includes the public key that can be used to verify the signature contained in the RRSIG record. The DNSSEC provides an elaborate chain of trust based on digital signatures leading back to the root domain. Thus, a response to a DNSSEC query can be fully verified without relying on a self-signed certificate-authority certificate or other such incompletely verifiable information. The RR types additionally include the “NSEC” and “NSEC3” RR types 834 that represent negative responses to DNS queries. The NSEC3 RR is a feature of DNSSEC that was not present in DNS that is designed to prevent zone locking attacks on the DNSSEC system that allow inferences to be made with respect to valid name-space information from information contained in negative-response RRs.

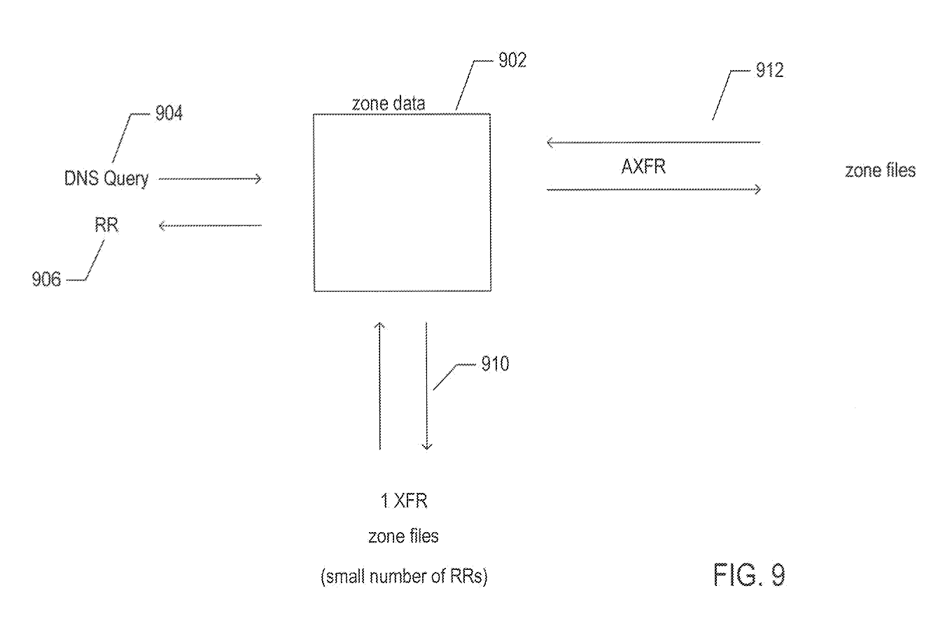

FIG. 9 illustrates data flow to and from zone data managed within DNSSEC servers of a DNSSEC zone. In FIG. 9, the zone data is represented by rectangle 902, generally a very large number of indexed RRs distributed across multiple computer systems. A DNS query issued to the DNSSEC 904 generally returns a particular RR 906 representing a response to the query. For example, a DNS query may seek the IP address of the mail server for a particular domain, in response to which the DNSSEC returns the MX RR containing that IP address along with additional information. In addition, RRs can be transferred among DNSSEC computer systems as zone files using the IXFR protocol 910 for small numbers of RRs and the AXFR protocol 912 for large zone files containing numerous RRs.

As discussed above, there are significant deficiencies in current public/private-key-based secure communications due to reliance on self-signed certificate-authority public-key certificates as well as difficulties in distributing and managing public-key certificates. As also discussed above, the DNSSEC system, a secure version of the DNS implemented during the past decade and deployed at the root level in 2011, provides for a fully verifiable distribution of information stored within the DNSSEC system and currently stores public-key certificates in CERT RRs for internal use within the DNSSEC. The current application is directed to additional client-side and DNSSEC components that together can provide for distribution and management of user and organizational public-key certificates through the DNSSEC. This new public-key-certificate distribution and management system (“CDMS”) enables a wide variety of reliable, simple, computationally efficient, and cost-effective secure-communications and information-verification methods to be carried out by a wide variety of different clients and users of electronic computing systems. Distribution of public-key certificates in a fully verifiable manner protected by a chain of trust leading back to the root domain of the DNSSEC, combined with appropriate use of public/private-key cryptography, closes many of the potential breaches of current public/private-key-based secure communications.

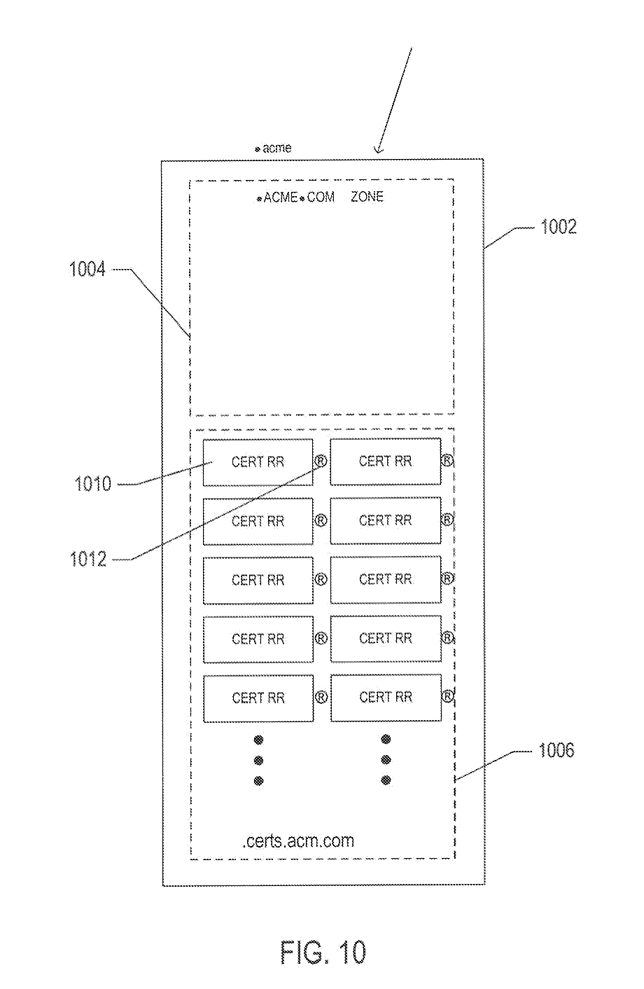

FIG. 10 illustrates the extension of the DNSSEC that makes possible the currently disclosed CDMS. FIG. 10 continues the description of the “.acme” name-space domain discussed above with reference to FIGS. 6 and 7. An organization, such as the Acme Corporation, which manages the “.acme” name-space domain on behalf of the Acme Corporation, as well as other organizational that employ the currently disclosed CDMS, including Internet service providers, creates and manages a new subdomain and corresponding subzone to contain published public-key certificates, stored in CERT RRs, for users and other entities within the Acme organization. In FIG. 10, the DNSSEC node corresponding to the “.acme” domain 1002 is shown to include a corresponding zone for the “.acmc.com” domain 1004 as well as a new subzone 1006 corresponding to the new subdomain “.certs.acme.com” of the “.acme.com” domain. The “certs” subdomain of a given domain thus serves as a repository and database for published public-key certificates entities within the parent domain of the “certs” subdomain. The public-key certificates, stored in CERT RRs within the DNSSEC servers of the subzone that manages the new “certs” subdomain are each associated with a flag indicating whether or not the associated CERT RR has been revoked. In FIG. 10, each of the CERT RRs, such as CERT RR 1010, is shown associated with the revocation flag, such as revocation flag 1012 associated with CERT RR 1010. The CERT RRs within the certs subdomain are indexed by cryptographic/hash digests of an identifier of the entity to which the public-key certificate contained in the CERT RR is bound, or the entity which owns the public-key certificate. Thus, information about the identities of entities within an organization cannot be obtained merely by guessing entity names and using NSEC RRs returned by unsuccessful DNS queries to infer names and/or identities of entities associated with a DNSSEC domain. In one implementation of the CDMS, published public-key certificates are associated with email addresses of the entities to which they belong, and it is email addresses that are cryptographically hashed to produce digests by which corresponding public-key certificates can be obtained from DNSSEC using DNSSEC queries.

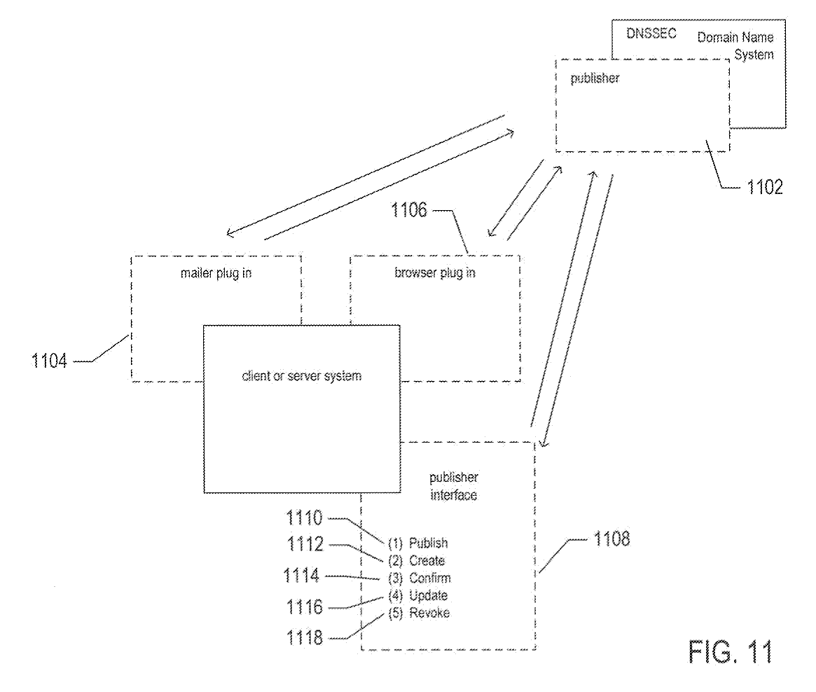

FIG. 11 illustrates additional components of the CDMS to which the current application is directed. The CDMS employs public-key certificates stored within the DNSSEC, as discussed above with reference to FIG. 10, as well as a new functional component referred to as the “publisher” component 1102. The publisher component implements the publisher side of CDMS protocols that allow public-key certificates to be published on behalf of client entities. The new publisher component may be implemented within existing DNSSEC server, may be implemented in stand-alone hardware appliances interconnected with DNSSEC servers, or may be implemented in other types of systems that intercommunicate with client computers and DNSSEC. The client-side CDMS protocol is implemented in one or more of mailer plug-ins 1104, browser plug-ins 1106, and new publisher-interface client-side applications 1108. The client-side component or components implement the client side of a publisher interface comprising the publisher-interface functions publish 1110, create 1112, confirm 1114, update 1116, and revoke 1118. Again, the publisher interface may be implemented by a mailer plug-in, browser plug-in, or new publisher-interface application, or a combination of these types of implementations. In addition, mailer plug-ins and browser plug-ins may implement additional functionality associated with the CDMS.

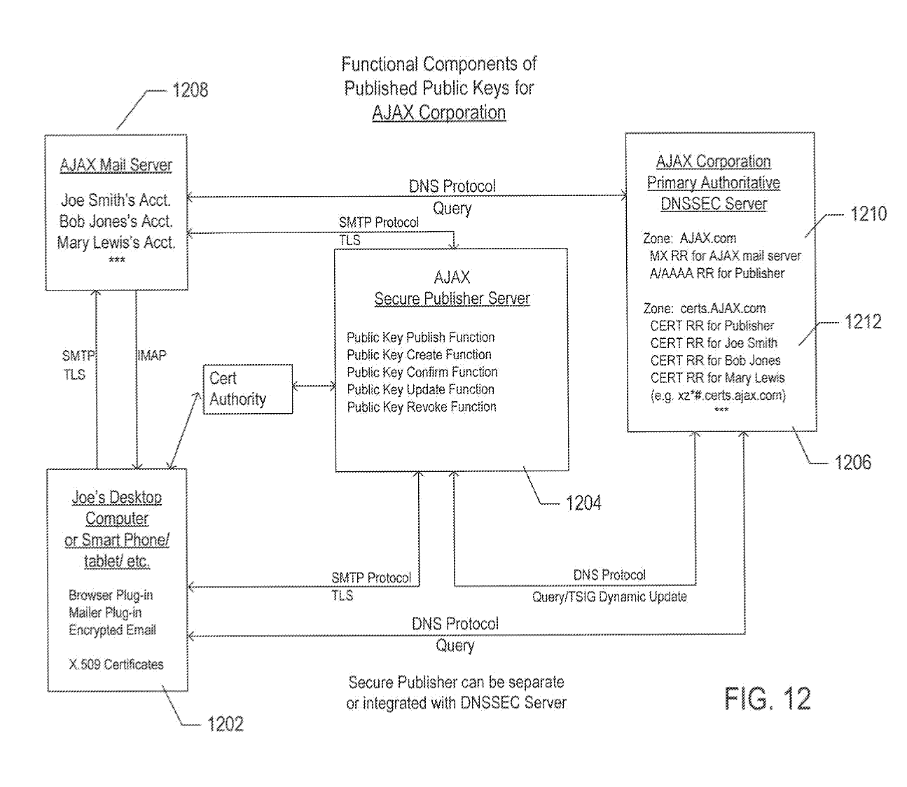

FIG. 12 shows components of the CDMS for a hypothetical Ajax Corporation. FIG. 12 shows the desktop computer for a user within the Ajax Corporation 1202, a publisher component 1204 of the CDMS locally managed by the Ajax Corporation, a primary authoritative DNSSEC name server for the Ajax Corporation locally managed by the Ajax Corporation 1206, and the mail server for the Ajax Corporation 1208. The primary authoritative DNSSEC server 1206 manages the ajax.com zone 1210 as well as the certs subdomain of the ajax.com domain 1212 in which published public-key certificates are stored. The publisher 1204 implements the publisher portion of the CDMS protocol while the client-side portion of the CDMS protocol is implemented in a browser plug-in and mailer plug-in within the user's desktop computer 1202. FIG. 12 shows the various underlying communications protocols used for communication between the various components of the CDMS, including the simple message transfer protocol (“SMTP”), DNS protocol, and secure communications protocol TLS 1.1 or later versions of the TLS secure protocol.

Next, the publisher interface functions publish, create, confirm, update, and revoke are described. The function publish is invoked to publish a public-key certificate by a user or other entity. Publication results in storing the public-key certificate in the certs subdomain of the user or other entity's domain in the DNSSEC, allowing external mail servers and other computational entities to access the published public-key certificate by generating a cryptographic-hash digest of an identifier, generally an email address, of the user or other entity. A user furnishes a public-key certificate to the publisher in invoking the publish function. The create function is similar to the publish function, except that a new public/private key pair is generated by the publisher and a public-key certificate binding the newly created public key to the invoking user or entity is created and stored in the DNSSEC by the publisher. In other words, the create function also publishes a public-key certificate on behalf of a user or other entity and, in addition, creates the public key and a corresponding private key prepares a public-key certificate on behalf of the user or entity. The create function returns the newly created private key securely to the user or other entity. In essence, the create function eliminates the need for external certificate authorities, with the DNSSEC instead providing fully verifiable public-key certificates to user and other entities. The confirm function is used to confirm publication of a public key certificate as well as the revocation status of the public-key certificate. The update function is similar to the create function, except that the update function replaces any currently existing public-key certificate with a corresponding new public-key certificate whereas the create function and publish function both fail in the case that a valid, non-revoked public-key certificate is already present within the DNSSEC for the user or entity. The revoke function removes a public-key certificate from the user or other entity's computer system and marks the corresponding published public-key certificate in the DNSSEC as revoked.

In certain cases, the CDMS can support only a single public-key certificate for each user and other entities. In the more general case, the CDMS may support an arbitrary number of public-key certificates for users and entities, each of the public-key certificates is associated with a role or type. In the more general case, a user or entity may have only a single public-key certificate published, at any given time, for a particular role or type.

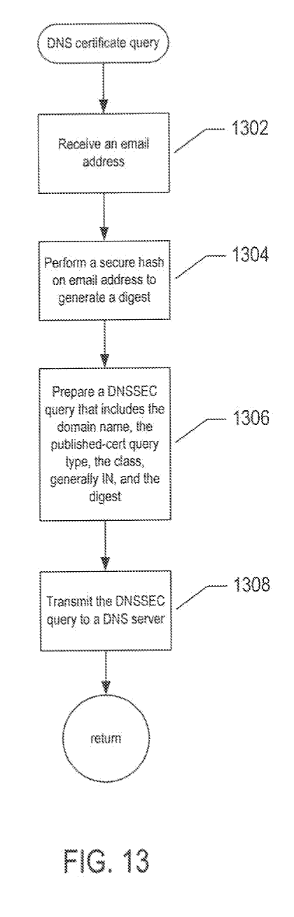

In one implementation of the CDMS, the CDMS uses standard DNSSEC queries to to provide a DNSSEC published-Cert query. The DNS published-cert query can be issued to the DNSSEC by computational entities, such as mail servers, that currently access the DNSSEC through DNSSEC queries. FIG. 13 illustrates, using a control-flow diagram, a DNSSEC certificate query carried out by a mail server or other DNSSEC publisher to retrieve a public-key certificate. In step 1302, the querying entity receives an email address and, in certain cases, a type or role indication that identifies the public-key certificate to be retrieved from the DNSSEC. In step 1304, the querying entity performs a cryptographic hash on the email address or a combination of the email address and type of role indication to generate a digest. In step 1306, the querying entity prepares a DNSSEC published-cert query that requests return of a CERT RR containing a published-key certificate identified by the digest generated in step 1304. The DNSSEC published-cert query additionally includes indications of a class and the published-cert query type. In step 1308, the querying entity transmits the DNSSEC published-cert query to a DNS server.

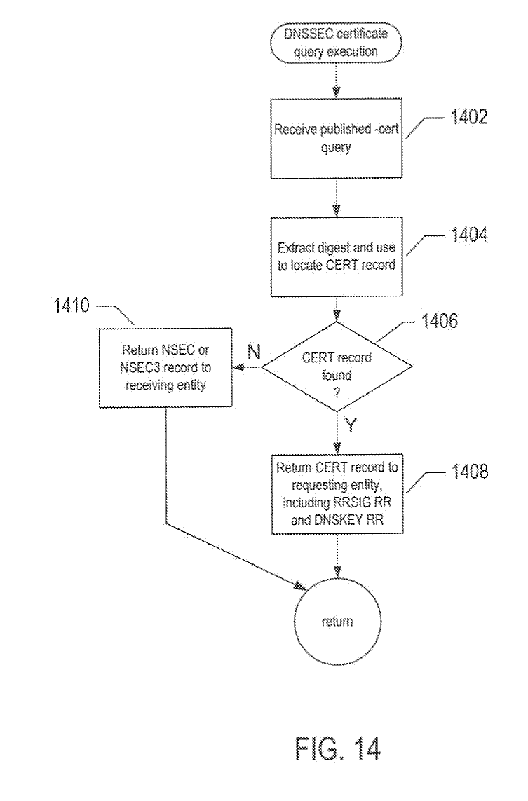

FIG. 14 illustrates execution of a DNSSEC published-cert query by a DNS server. In step 1402, the DNS server receives the published-cert query. When a request received by a DNS server stores or caches the appropriate CERT RRs, then query execution proceeds as in FIG. 14. Otherwise, the DNS server forwards the query on to the DNSSEC system to a DNSSEC server that can execute the query. These recursive forwarding operations are not shown in FIG. 14. In step 1404, the digest is extracted from the published-cert query and used as an index to attempt to locate a CERT RR that stores the sought public-key certificate. When the CERT RR corresponding to the digest is found, as determined in step 1406, then the CERT RR is returned to the requesting entity, along with an RRSIG RR and DNSKEY RR to verify the returned cert record in step 1408. Otherwise, when a CERT RR cannot be found, the DNSSEC server returns either an NSEC or NSEC3 RR to the requesting entity in step 1410.

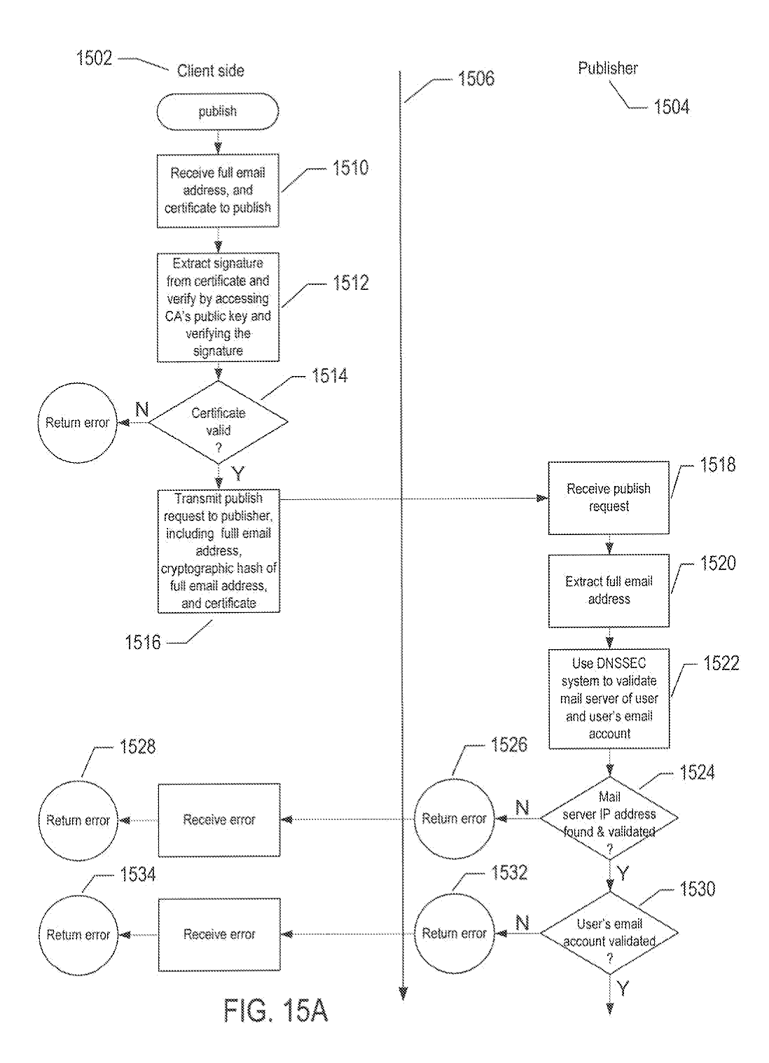

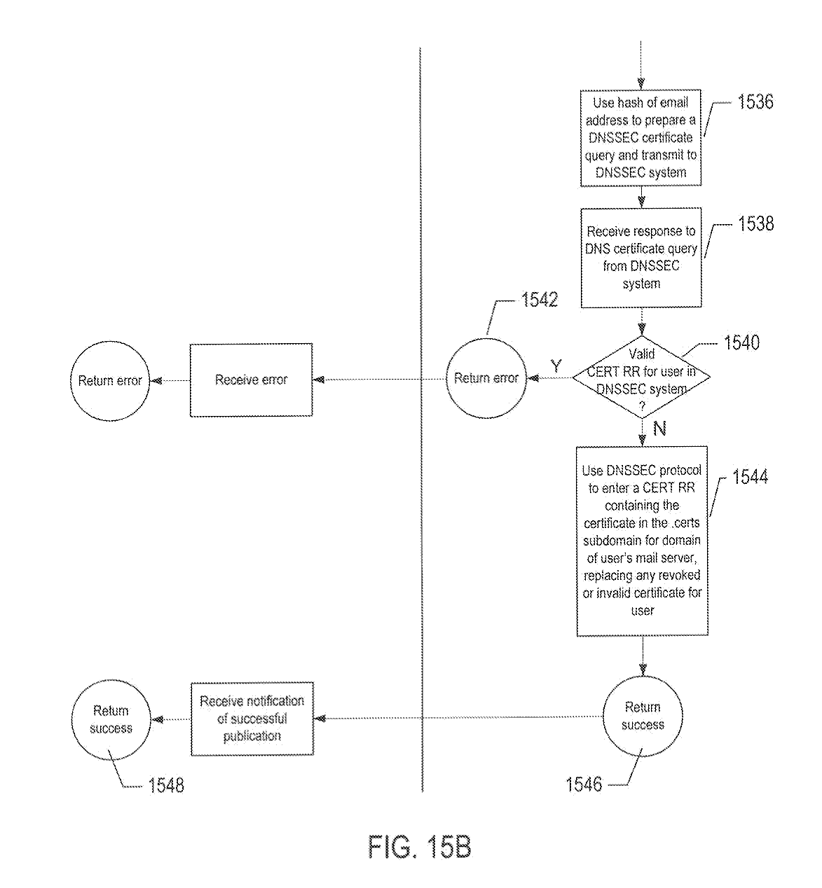

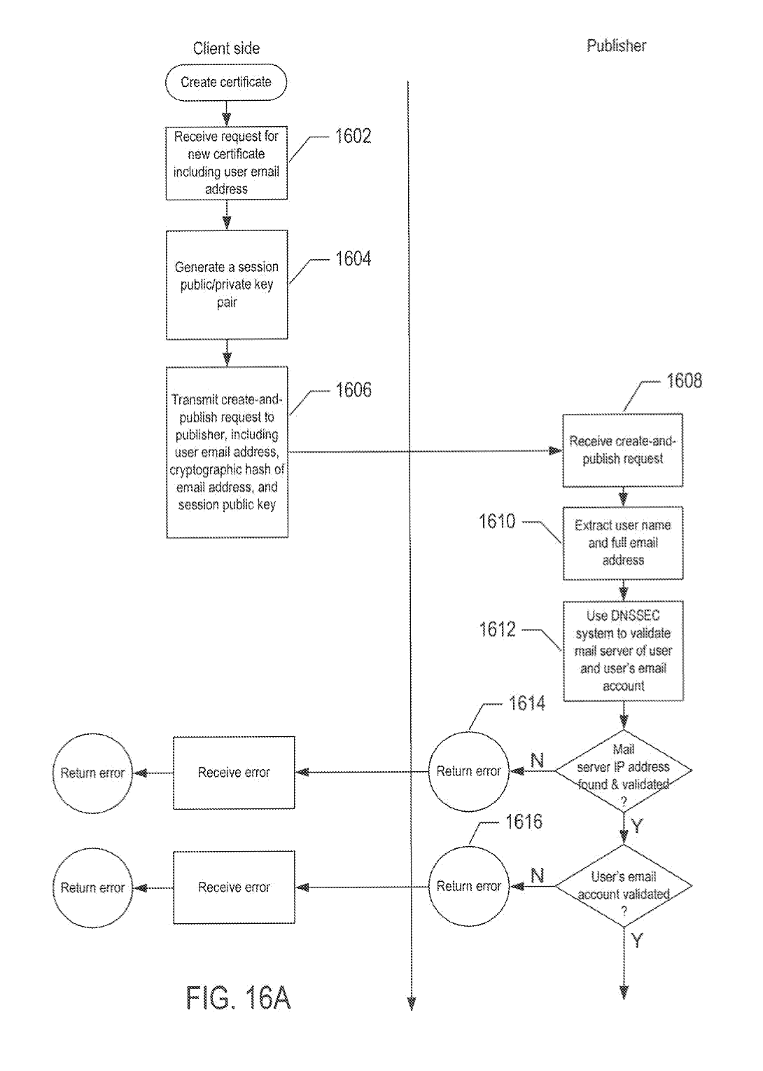

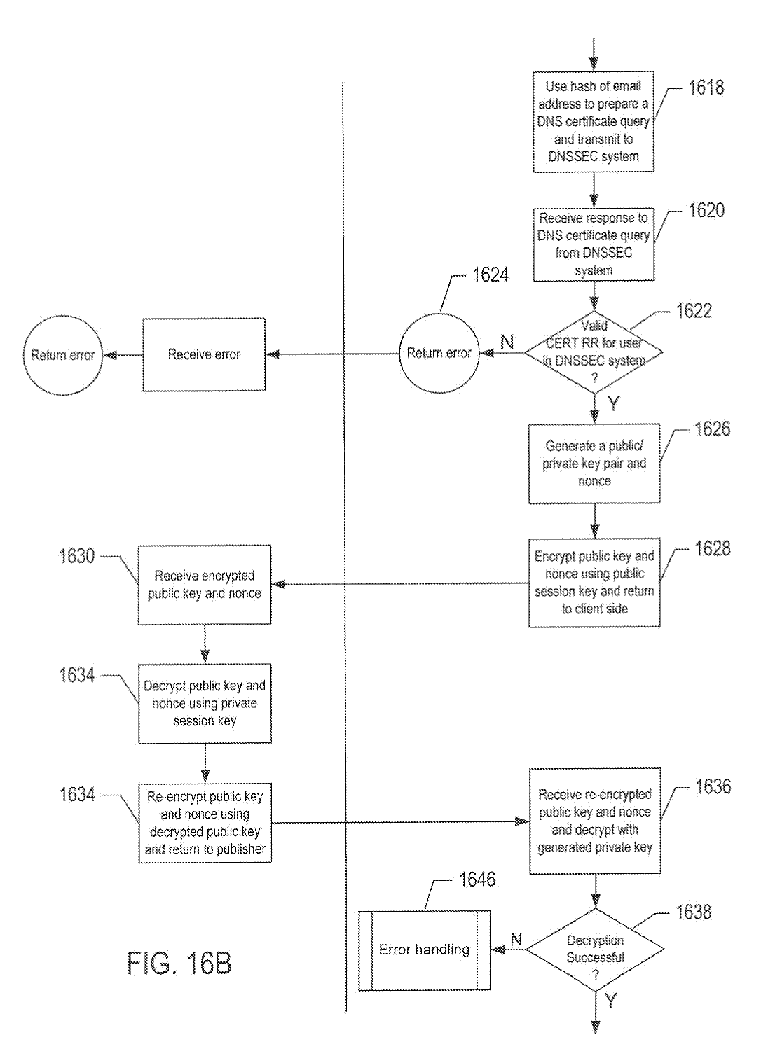

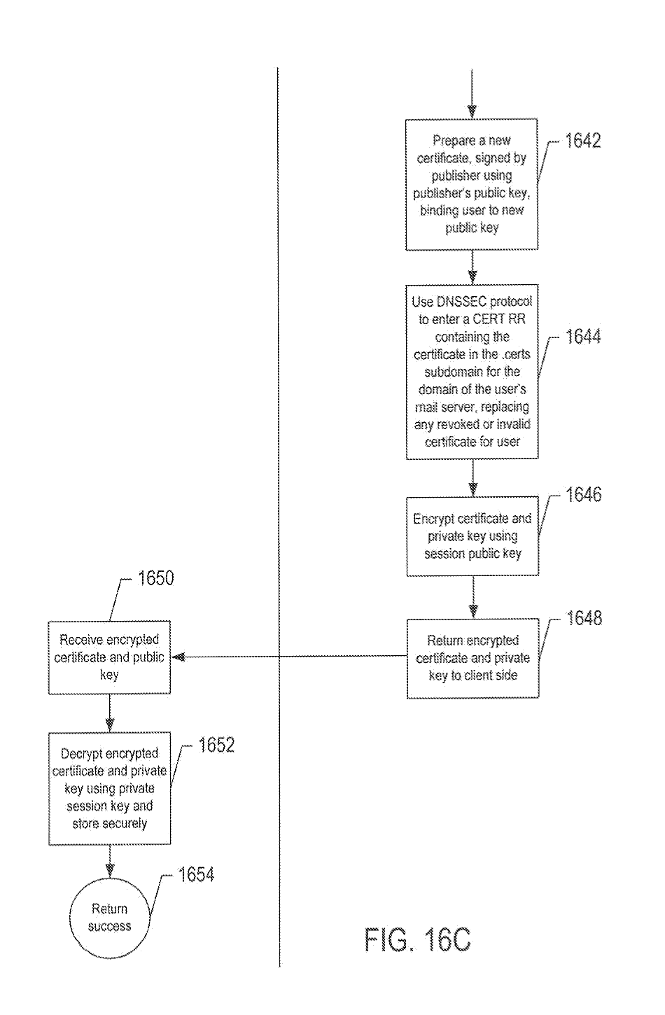

FIGS. 15A-B illustrate implementation of the publish function of the publisher interface. In these figures, as in FIGS. 16A-C that follow, the client-side portions of this function are shown on the left-hand portion of the figure and the publisher portions of the implementation are shown on the right-hand portion of the figure, as indicated by the phrase “client side” 1502, the term “publisher” 1504, and the vertical line 1506 partitioning the figure. In step 1510, a client-side portion of the publisher functionality receives a user name, the full email address or other identifier for the user, and an already-existing public-key certificate that the user or other entity wishes to publish. In step 1512, the client-side publish functionality verifies the public-key certificate with appropriate means, such as by accessing the certificate-authorities public-key certificate and verifying the signature of the public-key certificate received in step 1510. When the certificate is not valid, as determined in step 1514, then an error is returned. Otherwise, a request to publish the public-key certificate received in step 1510 is transmitted, in step 1516, to the publisher-side functionality of the publisher function. The request includes the user name, a cryptographic hash of the full email address of the user or other identifier, and the public-key certificate received in step 1510. In step 1518, the publisher-side functionality receives a published request and, in step 1520, the publisher extracts the full email address from the request. In step 1522, the publisher validates the user's email account, the IP address of the user's mail server, and any other information needed to verify the user or other requesting entity. The publisher may carry out this validation by directly communicating with the mail server or by accessing mail-server information from the DNSSEC as well as communicating with the mail server. When the mail server IP address is not validated, as determined in step 1524, then an error is returned to the client side in step 1526 resulting in the client side returning an error to the user or a user application or plug-in that invoked the publish function in step 1528. Otherwise, if the user's email account fails to be validated, as determined in step 1530, then an error is returned in step 1532 to the client side resulting in a return of an error to the user or a user application or plug-in in step 1534.

Continuing to FIG. 15B, once the server IP address and user mail account is verified, then the publisher uses the digest included in the publish-request message to prepare a DNSSEC published-cert query and transmits the query to the DNSSEC in step 1536. In step 1538, the publisher receives a response from the DNSSEC system. When the DNSSEC system returns a CERT RR containing a valid and unrevoked public-key certificate, as determined in step 1540, then an error is returned, in step 1542, to the client side which propagates back to the user or a user-invoked plug-in or application. Otherwise, in step 1544, the publisher uses the IXFR protocol or another means to transfer a CERT RR constructed by the publisher to contain the received public-key certificate to the DNSSEC for storage in the “.certs” subdomain of the domain of the user's mail server. In the DNSSEC side, the CERT RR furnished by the publisher replaces any revoked or invalid certificate currently stored in association with the digest, also furnished to the DNSSEC, and the revoked flag is cleared. Thus, as a result of execution of step 1544, the published-key certificate received in step 1510 at the client side is now stored and marked unrevoked within the DNSSEC and is effectively published. An indication of a successful completion is returned, in step 1546, to the client side which propagates the successful completion to the user or a user plug-in or application in step 1548.

FIGS. 16A-C illustrate implementation of the create publisher function. Many of the steps in the create publisher function are identical to, or equivalent to, corresponding steps in the publish function, discussed above with reference to FIGS. 15A-B, and are therefore not again described, in detail, in the following discussion. In step 1602, a request for a new certificate is received. In step 1604, the client-side portion of the create function generates a new public/private-key pair for entering a session or transaction. In step 1606, the client-side portion of the create function transmits a create-and-publish request to the publisher that includes the email address of the user, and the session public key generated in step 1604. In step 1608, the publisher receives the create-and-publish request and extracts the email address of the user from the request in step 1610. In step 1612, the publisher verifies the IP address of the user's email server as well as the user's email account. When the validation fails, error indications arc returned in steps 1614 and 1616 as in the above-described publisher function. When verification succeeds, the publisher prepares a DNS published-cert query in step 1618 using the digest included in the create-and-publish request and, in step 1620, receives a response from the DNSSEC. When the DNSSEC responds with a valid and unrevoked CERT RR containing a public-key certificate for the user and/or role or type, as determined in step 1622, then an error is returned in step 1624. Otherwise, the publisher generates a new public/private key pair and a cryptographic nonce in step 1626. The publisher then encrypts the public key and nonce using the public session key provided in the create-and-publish request in step 1628. The encrypted public key and nonce are then transmitted to the client side which receives the encrypted public key and nonce in step 1630. In step 1632, the client side decrypts the public key and nonce using the private session key generated in 1604. Then, in step 1634, the client side re-encrypts the public key and nonce using the decrypted public key transmitted by the publisher in step 1628 and returns the re-encrypted public key and nonce to the publisher in step 1634. In step 1636, the publisher receives the re-encrypted public key and nonce and decrypts the re-encrypted public key and nonce using the private key generated in step 1628. When the decryption is unsuccessful, as determined in step 1638, then error handling is invoked in step 1640. This may constitute simply returning an error indication or may involve a second attempt to carry out steps 1626 and 1636 or some alternative handshake-type operation. When the decryption is successful, then, in step 1642, the publisher prepares a new public-key certificate signed by the publisher using the publisher's public key which binds the user or other entity requesting the new certificate to the public key created in step 1628. In step 1644, the publisher transmits this new public-key certificate to the DNSSEC for storage in the “.certs” subdomain of the domain of the user's email server, replacing any revoked and/or invalid certificates associated with the digest also furnished to the DNSSEC in step 1644. In step 1646, the publisher re-encrypts the newly prepared public-key certificate and the private key generated in step 1628 and returns the re-encrypted certificate and private key to the client side in step 1648. In step 1650, the client side receives the encrypted certificate and private key and decrypts and stores both the certificate and private key in step 1652, returning success to the user and/or a user plug-in or application in step 1654.

The confirm publisher-interface function is more simply implemented than the above-described publish and create functions. The publisher is only to use the digest for the email address of a user or, in certain cases, a digest of the user's email address as well as a role or type of public-key certificate, to request and to receive the public-key certificate from the DNSSEC. The DNSSEC returns the RRSIG RR and DNSKEY RR, discussed above, along with the CERT RR containing the public-key certificate that can be used by the publisher to validate the CERT RR and public-key certificate contained within the CERT RR. As discussed above, the DNSSEC system provides a full chain of trust all the way back to the DNSSEC root domain, providing full verification. The update publisher function is similarly implemented as the create publisher function, with the exception that the update publisher-interface function deletes, on the client side, any public-key certificate currently stored within the user's system and removes any public-key certificates stored within the DNSSEC prior to undertaking creation and publishing of a new public key for the user. As mentioned above, the revoked publisher-interface function revokes the currently stored public-key certificates on the client side within the user's system as well as stored within the DNSSEC. In both update and revoke, the publisher first validates the IP address of the user's email server and the user's email account before undertaking update and revoke operations. The update and revoke may be directed to a single public-key certificate associated with a user, in certain CDMS implementations, and may be directed to a particular public-key certificate having a specified role or type for a user.

The CDMS securely publishes public-key certificates for a wide variety of different types of users and entities. These published public-key certificates become available to any computing system, such as a mail server, that currently accesses the DNSSEC through DNSSEC queries. As a result, the published public-keys can be used as the basis for a wide variety of different types of secure communications, secure transactions, or digitally encoded information verification via digital signatures. For example, a mailer plug-in can retrieve the public-key certificate for the address fee of an email being sent by a user and, when receiving a valid and unrevoked public-key certificate corresponding to the addressee, can encrypt the message using the addressee's published public key prior to transmission. Thus, a message sender need not have first received a public-key certificate from the addressee and can verify association of the public-key certificate with the addressee through the DNSSEC other than relying on external certificate authorities or other secure means. Published public-key certificates can be used for validation of distributed software, for automated spam-email-detection, and for implementing a variety of different extremely secure transaction protocols that strongly authenticate the parties to the transaction.

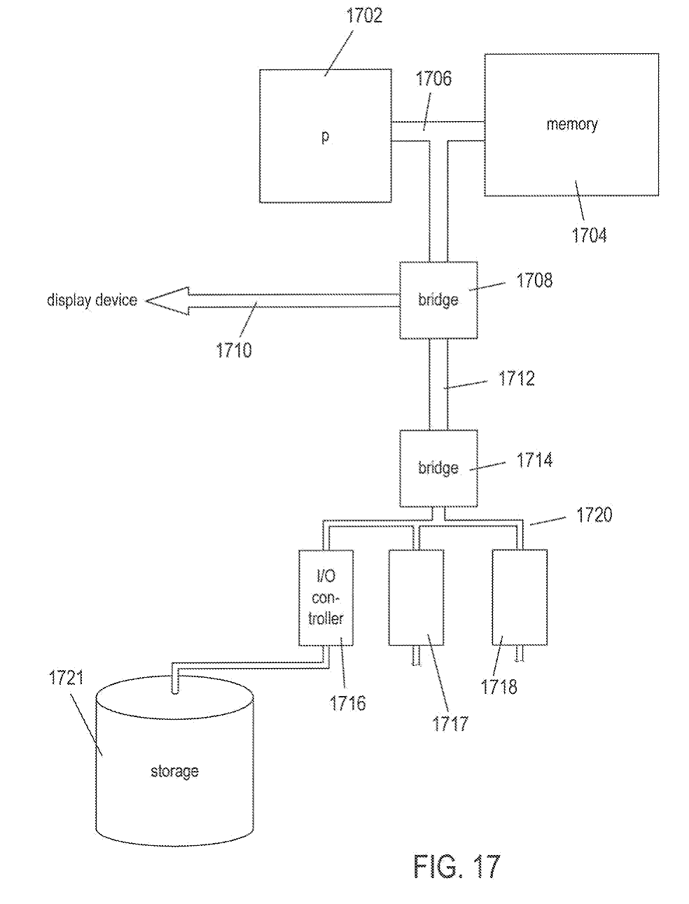

FIG. 17 provides a block diagram of a generalized computer system on which components of the certificate distribution and management system are implemented. The computer includes a processor 1702, memory 1704, a memory/processor bus 1706 that interconnects the processor, memory, and a bridge 1708. The bridge interconnects the processor/memory bus 1706 with a high-speed data-input bus 1710 and an internal bus 1712 that connects the first bridge 1708 with a second bridge 1714. The second bridge is, in turn, connected to various devices 1716-1718 via high-speed communications media 1720. One of these devices is an I/0 controller 1716 that controls data exchange with a mass-storage device 1721. A software program that implements a video codec may be executed by the computer system to control video coding by the computer system. In this example, the software program is stored on the mass-storage device 1720 and paged, on an as-needed basis, into memory 1704. Instructions of the software program are fetched, by the processor 1702, from memory for execution. The phrase “electronic memory” refers to any of numerous data-storage components, including system memory, caches, mass-storage devices, and other such components that store computer instructions and program data for subsequent access.

Although the present invention has been described in terms of particular embodiments, it is not intended that the invention be limited to these embodiments. Modifications within the spirit of the invention will be apparent to those skilled in the art. For example, the publisher functionality can be distributed among client-side and publisher-side portions in a variety of different ways. The publisher interface may include additional functions or variations on the publisher functions addressed above. Variations may include different, additional, or fewer arguments in different implementations. As discussed above, the publisher functionality may be embodied in special-purpose hardware devices or in software implementations included in DNS servers or other systems. A variety of different hardware platforms may be used for implementing the publisher functions, and publisher routines can be implemented in many different ways by varying any of the many different design and implementation parameters, including control structures, modular organization, data structures, programming language, and other such parameters. While email addresses are an attractive option for identifiers bound to public keys by published-key certificates, other types of identifiers may alternatively be used.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A public-key-certificate publishing system comprising:
a client-side publisher component, executed on a client computer system and stored in an electronic memory within the client computer system, that, in response to a client-computer-system event, transmits a create-and-publish request and transmits the create-and-publish request to a publisher component; and
a publisher component implemented as a hardware appliance or executed on a computer system, such as a DNSSEC server, the publisher component receiving the create-and-publish request from the client-side publisher component and executing the create-and-publish request by:
verifying a mail server associated with the client computer system and a user account managed by the mail server,
creating a new public/private key pair,
creating and public-key certificate that binds a user of the client computer to the created public key, and
transfers the public-key certificate to the DNSSEC for storage in a CERT RR within a “.certs” subdomain of the domain of the mail server.
